(19) United States
(12) Patent Application Publication
(10) Pub. No.: US 2023/0347575 A1
(43) Pub. Date: Nov. 2, 2023

(54) PHOTOSENSITIVE POLYIMIDE RESIN FOR ULTRAVIOLET (UV) CURING-BASED 3D PRINTING AND PREPARATION METHOD THEREOF

(71) Applicant: SHAANXI UNIVERSITY OF TECHNOLOGY, Hanzhong (CN)

(72) Inventors: Feng XU, Hanzhong (CN); Lei FU, Hanzhong (CN); Haiqing BAI, Hanzhong (CN); Fanying MENG, Hanzhong (CN); Fanke LI, Hanzhong (CN); Xiaokui ZHUO, Hanzhong (CN); Shikui JIA, Hanzhong (CN)

(21) Appl. No.: 18/348,196

(22) Filed: Jul. 6, 2023

Related U.S. Application Data
(63) Continuation of application No. PCT/CN2023/095755, filed on May 23, 2023.

(30) Foreign Application Priority Data
Mar. 7, 2023 (CN) 202310214490.4

(51) Int. Cl. B29C 64/106; B29C 64/314; B33Y 70/00; C08G 73/10

(52) U.S. Cl. CPC B29C 64/106; B29C 64/314; B33Y 70/00; C08G 73/1028; B29K 2079/08

(57) ABSTRACT

A photosensitive polyimide resin for ultraviolet curing-based three-dimensional printing, which is prepared from 40-60 parts by weight of an active group-containing polyimide resin; 20-50 parts by weight of an organic activator; and 2-5 parts by weight of a photoinitiator. This application further provides a method for preparing the photosensitive polyimide resin.

### CROSS-REFERENCE TO RELATED APPLICATIONS

This application is a continuation of International Patent Application No. PCT/CN2023/095755, filed on May 23, 2023, which claims the benefit of priority from Chinese Patent Application No. 202310214490.4, filed on Mar. 7, 2023. The content of the aforementioned application, including any intervening amendments thereto, is incorporated herein by reference in its entirety.

### TECHNICAL FIELD

This application relates to 3D printing, and more particularly to a photosensitive polyimide resin for ultraviolet (UV) curing-based three-dimensional (3D) printing and a preparation method thereof.

### BACKGROUND

Three-dimensional printing (3DP), also known as additive manufacturing (AM), is a rapid prototyping technology, in which a physical 3D object is created from a digital model file by laying down successive layers of materials (such as powdered metal and plastic). Currently, the predominant 3DP techniques are Stereo Lithography Appearances (SLA) and Digital Light Processing (DLP), which are based on the photopolymerization of liquid photosensitive resins. Under the irradiation of ultraviolet light with a certain wavelength (x=325 nm) and intensity (w=30 mw), the liquid photosensitive resin will undergo rapid photopolymerization, and experience a sharp increase in the molecular weight, such that the material is converted from liquid state into solid state.

At present, the photosensitive resins used for commercial SLA or DLP printing mainly include acrylate resin, epoxy resin, and polyurethane-based resin. The acrylate resin and epoxy resin have high UV curing speed and excellent curing precision, but struggle with poor mechanical strength and large brittleness. Polyurethane acrylate (PUA) resin has superior toughness and small shrinkage, but it is expensive and, has poor heat resistance.

Polyimide (PI) refers to a class of polymers containing imide rings (—CO—NR—CO—) on the main chain, and is one of the organic polymer materials with optimal comprehensive performance. PI exhibits an exceptional thermal stability (above 400° C.), and can keep stable under the long-term exposure to −200˜300° C. (some of the polyimides have no melting point). Moreover, the PI has excellent insulation performance, where the dielectric constant is 4.0 at 10³ Hz (F to H class insulation), only has a dielectric loss of 0.004˜0.007. Due to outstanding physical and chemical characteristics, PI has been widely used in aviation, aerospace, microelectronics, nanotechnology, liquid crystal, separation membrane, and laser as structural materials or functional materials. However, in addition to the excellent comprehensive properties, the rigid molecular chain also brings the problem of poor solubility and inferior melting behavior. Therefore, it is difficult to make structurally-complex three-dimensional PI objects.

In recent years, a great deal of attention has been paid to the application of polyimide in 3D printing. Chinese patent publications No. 105837760A and No. 108748976A both disclosed a photocurable polyimide ink and a direct-ink-writing (DIW) method thereof, in which the 3D printing is carried out by the DIW additive manufacturing process, and the self-made equipment is similar to the fused deposition modeling (FDM) printer. A non-patent literature (J. Mater. Chem. A, 2017, 5, 16307-16314) introduces the preparation of a photocurable polyimide resin and a DLP printing. The reported preparation has complicated operation, and the fabricated architectures require high-temperature post-treatment. Therefore, it is necessary to provide a photosensitive polyimide resin with excellent performance, simple preparation process and low requirements for printing equipment.

### SUMMARY

In view of the deficiencies in the prior art, this application provides a photosensitive polyimide resin for UV curing-based 3D printing and a preparation method thereof.

Technical solutions of this application are described as follows.

In a first aspect, this application provides a photosensitive polyimide resin for ultraviolet (UV) curing-based three-dimensional (3D) printing, wherein raw materials for preparation of the photosensitive polyimide resin include:
40-60 parts by weight of an active group-containing polyimide resin;
20-50 parts by weight of an organic activator; and
2-5 parts by weight of a photoinitiator;
wherein the organic activator comprises methyl methacrylate (MMA) and 1-vinyl-2-pyrrolidone (NVP).

In an embodiment, raw materials for preparation of the active group-containing polyimide resin comprises:
5-15 parts by weight of 2-(4-aminophenyl)-5-aminobenzimidazole (APBIA);
10-20 parts by weight of 3,3′,4,4′-benzophenone tetracarboxylic dianhydride (BTDA);
0.03-0.05 part by weight of triethylamine (TEA);
1.71-5.12 parts by weight of glycidyl methacrylate (GMA);
0.12-0.36 part by weight of a polymerization inhibitor; and
a solvent.

In an embodiment, the polymerization inhibitor is selected from the group consisting of hydroquinone, 2-tert-butylhydroquinone (TBHQ), 2,5-di-tert-butylhydroquinone (DBHQ), and a combination thereof.

In an embodiment, the solvent is selected from the group consisting of N-methylpyrrolidone (NMP), N,N-dimethylformamide, N,N-dimethylacetamide, and a combination thereof.

This application further provides a method for preparing the photosensitive polyimide resin, including:
adding the active group-containing polyimide resin, the organic activator and the photoinitiator in a ball grinding mill followed by grinding in the dark for uniform mixing to obtain the photosensitive polyimide resin.

In an embodiment, the active group-containing polyimide resin is prepared through steps of:
adding APBIA into a solvent to obtain a first mixture;
adding BTDA into the first mixture for reaction to obtain a second mixture; and
adding TEA, GMA, and a polymerization inhibitor into the second mixture for condensation reaction to obtain the active group-containing polyimide resin.

In an embodiment, the step of “adding BTDA into the first mixture for reaction to obtain a second mixture” includes:
adding BTDA into the first mixture in an ice-water bath followed by stirring in an inert gas atmosphere, reaction in a hydrothermal reactor, reaction at a low temperature, and reaction in a heating system, so as to obtain the second mixture.

In an embodiment, the heating system is successively set at 120° C. for 2 h, 160° C. for 2 h, and 200° C. for 12 h.

In an embodiment, the “reaction at a low temperature ” is carried out at 4° C. for 24 h.

In an embodiment, the condensation reaction is carried out at 100° C. for 5 h.

Compared to the prior art, this application has the following beneficial effects.

The preparation process provided in this application is simple, and has less waste liquid production. The prepared photosensitive polyimide resin can be used in conventional commercial SLA or DLP printers, and the printed product has simple post-processing operation without high-temperature imidization, and will not suffer solvent volatilization and shrinkage, exhibiting excellent dimensional stability, high strength, and good heat resistance. The whole preparation process is environmentally-friendly.

### BRIEF DESCRIPTION OF THE DRAWINGS

FIG. 1 schematically shows a printed sample created using a photosensitive polyimide resin obtained in Example 1 of the present disclosure;

FIG. 2 shows a standard strip for tensile test;

FIG. 3 shows a strip for tensile test which is printed using the photosensitive polyimide resin obtained in Example 1 of the present disclosure;

FIG. 4 shows a thermogravimetric analysis (TGA) curve of a sample printed using the photosensitive polyimide resin obtained in Example 1 of the present disclosure;

FIG. 5 shows a TGA curve of a sample printed using the photosensitive polyimide resin obtained in Example 3 of the present disclosure;

FIG. 6a is a perspective of a printed impact strip;

FIG. 6b is a top view of the printed impact strip;

FIG. 7 shows a thickness of the printed impact strip; and

FIG. 8 shows a width of the printed impact strip.

### DETAILED DESCRIPTION OF EMBODIMENTS

In order to illustrate the object, technical solutions and advantages of the disclosure more clearly and completely, the disclosure will be further described below in conjunction with embodiments and drawings.

Unless otherwise expressly specified and defined, the test methods used in the following embodiments are conventional methods, and the materials, and reagents are commercially-available.

Raw materials for preparing a photosensitive polyimide resin include:
40-60 parts by weight of an active group-containing polyimide resin;
20-50 parts by weight of an organic activator; and
2-5 parts by weight of a photoinitiator.

In an embodiment, the active group-containing polyimide resin includes an acryloyl active group.

In an embodiment, raw materials for preparation of the active group-containing polyimide resin includes:
5-15 parts by weight of 2-(4-aminophenyl)-5-aminobenzimidazole (APBIA);
10-20 parts by weight of 3,3′,4,4′-benzophenone tetracarboxylic dianhydride (BTDA);
0.03-0.05 part by weight of triethylamine (TEA);
1.71-5.12 parts by weight of glycidyl methacrylate (GMA);
0.12-0.36 part by weight of a polymerization inhibitor; and a solvent.

Specifically, APBIA reacts with BTDA to form an imidized structure. APBIA contains benzimidazole heterocyclic units, which can improve the mechanical properties of the material after curing.

More specifically, glycidyl methacrylate (GMA) is a photosensitive unit that provides the active site for subsequent light curing.

In an embodiment, the active group-containing polyimide resin is prepared through the following steps.

The APBIA is added to the solvent to obtain a first mixture.

BTDA is added to the first mixture for reaction to obtain a second mixture.

The TEA, GMA, and polymerization inhibitor are added to the second mixture for condensation reaction to obtain the active group-containing polyimide resin.

In an embodiment, the step of “adding BTDA into the first mixture for reaction to obtain a second mixture” includes: adding BTDA into the first mixture in an ice-water bath followed by stirring in an inert gas atmosphere, and reaction in a hydrothermal reactor, reaction at a low temperature environment, and reaction in a heating system, to obtain the second mixture.

In an embodiment, the “reaction at a low temperature environment” is carried out at 4° C. for 24 h.

In an embodiment, the heating system is successively set at 120° C. for 2 h, at 160° C. for 2 h, and at 200° C. for 12 h. Specifically, the imidization of polyimide is carried out at 200° C. But directly rising to 200° C. is easy to cause side reactions. Therefore, the reaction temperature needs to be gradually risen, for example, can start from 80° C., be increased at 20° C./h, and finally keep at 200° C. for more than 10 h.

In an embodiment, the polymerization inhibitor is selected from the group consisting of hydroquinone, 2-tert-butylhydroquinone (TBHQ), and 2,5-di-tert-butylhydroquinone (DBHQ), and a mixture thereof.

In an embodiment, the solvent is selected from the group consisting of N-methylpyrrolidone (NMP), N,N-dimethylformamide, N,N-dimethylacetamide, and a combination thereof.

In an embodiment, the organic activator includes methyl methacrylate (MMA) and 1-vinyl-2-pyrrolidone. Specifically, MMA has high activity and is easy to polymerize when irradiated or heated by ultraviolet light. MMA as the second active photosensitive unit is beneficial to improve the efficiency of UV curing. In an embodiment, the photosensitive polyimide resin is applied to the SLA or DLP printer.

The disclosure provides a method for preparing the photosensitive polyimide resin, including: adding the active group-containing polyimide resin, the organic activator, and the photoinitiator in a ball grinding mill followed by grinding in the dark place for uniform mixing to obtain the photosensitive polyimide resin.

The organic activator includes methyl methacrylate and 1-vinyl-2-pyrrolidone.

The raw material compositions of Examples 1-4 were shown in Table 1.

The active group-containing polyimide resin was prepared by the following steps.

10.76 g (48 mmol) of APBIA was added into 80 mL of NMP followed by stirring in N₂ atmosphere to disperse APBIA evenly, so as to obtain the first mixture.

15.79 g (49 mmol) of BTDA was added to the first mixture in an ice-water bath followed by stirring in the N₂ atmosphere, pouring in a hydrothermal reactor (200 mL), filling N₂ into the hydrothermal reactor, and putting in the refrigerator for reaction at about 4° C. for 24 h, so as to obtain the second mixture. The hydrothermal reactor was removed from the refrigerator to room temperature. Then the hydrothermal reactor was placed in the heating system for reaction. Specifically, the heating system is successively set at 120° C. for 2 h, 160° C. for 2 h, and at 200° C. for 12 h, so as to obtain polyimide solution.

The polyimide solution was cooled to room temperature. 40 mg of TEA, 4.12 g of GMA, and 200 mg of hydroquinone were added into the polyimide solution in sequence, stirred well, and reacted at about 100° C. for 5 h while the hydrothermal reactor was covered, so as to obtain the reaction solution. Then the reaction solution was cooled to room temperature, placed in water for precipitation, filtrated by a vacuum pump, cleaned 3 times, and dried in an oven 50° C. for 12 h, to obtain light-yellow powder A, which was active group-containing polyimide resin. The washing water was deionized water, and the dosage of water was 100 mL/time.

The photosensitive polyimide resin was prepared through the following steps.

The active group-containing polyimide resin A, the photoinitiator (Irgacure 819), the organic activator MMA, and the solvent-activator NVP were placed in the ball grinding mill followed by grinding in the dark place for 2 h for uniform mixing to obtain the homogeneous viscous transparent photosensitive polyimide resin.

The photosensitive polyimide resins prepared in Examples 1-4 were placed in the storage tank of the ordinary commercial SLA printer. The printing conditions were set, and the finished products were printed. The printed products were rinsed off the adhering resin with water, wiped dry, and placed in a UV curing box to continue curing for 2 h to obtain the final samples.

The printing conditions were as follows:
Size (mm) 80.00*5.00*10.00;
Volume (ml) 4.00;
Number of triangular polygons 12; and
Number of vertices 36.

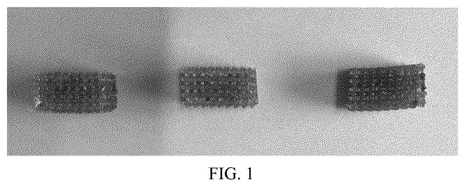

A photograph of the printed sample created using the photosensitive polyimide resin obtained in Example 1 was shown in FIG. 1.

TABLE 1
Raw material composition of Examples 1~4 (by weight)

| | Active | | | |
|---|---|---|---|---|
| | group-containing | | | |
| | polyimide resin | Photoinitiator | MMA | NVP |
| Example 1 | 40 parts | 2 parts | 20 parts | 20 parts |
| Example 2 | 40 parts | 5 parts | 10 parts | 30 parts |
| Example 3 | 60 parts | 2 parts | 20 parts | 20 parts |
| Example 4 | 60 parts | 5 parts | 10 parts | 30 parts |

Test results of viscosity and density of photosensitive polyimide resin prepared in

Examples 1-4 were shown in Table 2.

TABLE 2
Test results of viscosity and density of samples (25° C.)

| | Viscosity/cps | Density/g · cm⁻³ |
|---|---|---|
| Example 1 | 262 | 1.13 |
| Example 2 | 256 | 1.23 |
| Example 3 | 278 | 1.07 |
| Example 4 | 271 | 1.10 |

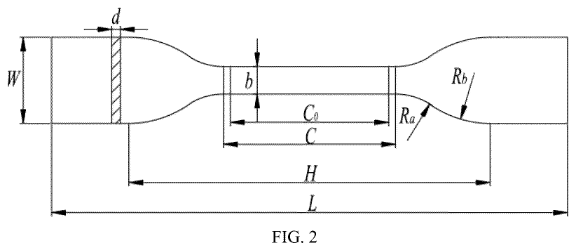

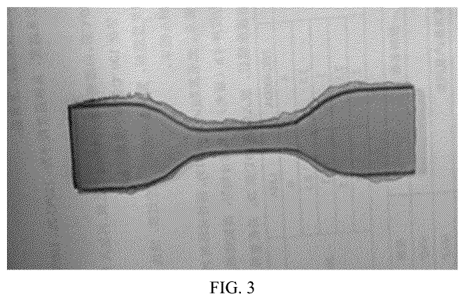

The tensile strength and volume shrinkage of the sample strips printed using the photosensitive polyimide resin prepared in Examples 1˜4 was tested. FIG. 2 showed a standard strip for tensile test (parameters (expressed by mm) were listed in Table 3). The sample strip for tensile test printed using the photosensitive polyimide resin obtained in Example 1 was shown in FIG. 3, and the test results of tensile strength and volume shrinkage were shown in Table 4.

TABLE 3
Parameters of the standard strip for tensile test

| Symbol | Name | Size | Tolerance |
|---|---|---|---|
| L | Overall length | 115 | — |
| | (minimum) | | |
| H | Distance between | 80 | ±5 |
| | fixtures | | |
| C | Length of middle | 33 | ±2 |
| | parallel section | | |
| C₀ | Gauge length | 25 | ±1 |
| | (or valid part) | | |
| W | End width | 25 | ±1 |
| d | Thickness | ≤2 | — |
| b | Width of middle | 5 | ±0.4 |
| | parallel section | | |
| Ra | Small radius | 14 | ±1 |
| Rb | Large radius | 25 | ±2 |

TABLE 4
Test results for tensile strength and volume shrinkage (25° C.)

| | Tensile strength/MPa | Volume shrinkage/% |
|---|---|---|
| Example 1 | 129 | 8.9 |
| Example 2 | 109 | 9.1 |
| Example 3 | 175 | 8.5 |
| Example 4 | 164 | 7.9 |

It could be seen from Table 4 that through testing the tensile strength and heat resistance of the sample strips printed using the photosensitive polyimide resin prepared in Examples 1˜4, it was proved that the strength and heat resistance of the samples after SLA printing and light curing were not different from the heat-cured polyimide on the market. In other words, the samples in this disclosure could meet the standard of polyimide on the market.

In addition, it was also verified that polyimide, prepared using acrylic acid, styrene, polyethylene glycol diacrylate, and lauryl methacrylate as reactive diluents, could not be used in light-curing 3D printers, could not be printed and molded, and was sludge-like.

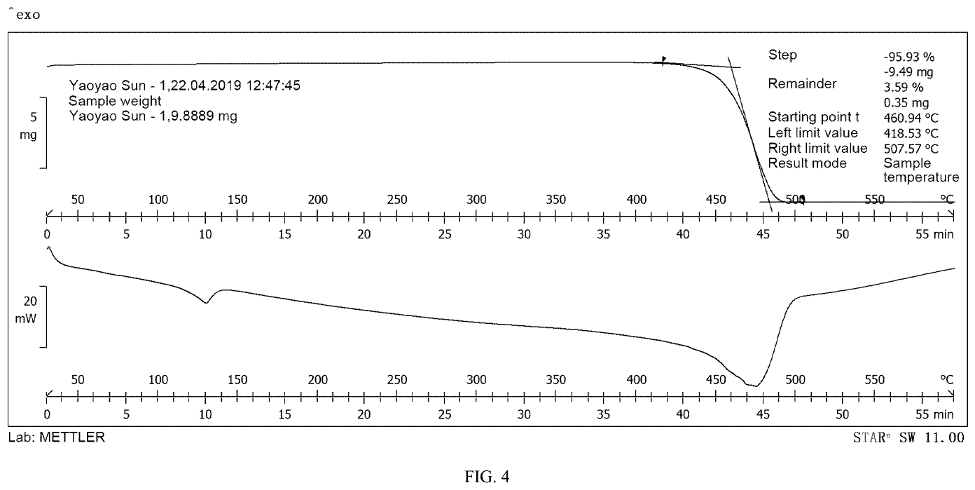

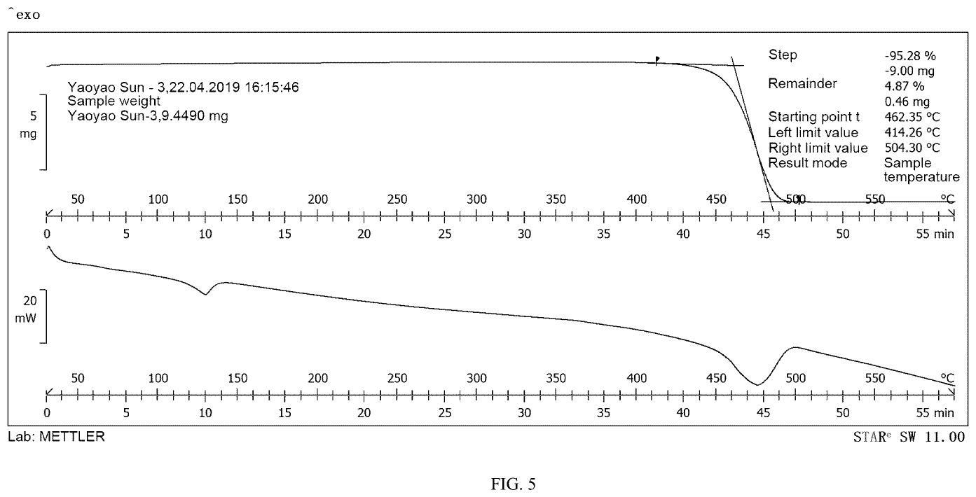

FIG. 4 showed a thermogravimetric analysis (TGA) curve of a sample printed using the photosensitive polyimide resin obtained in Example 1. FIG. 5 showed a TGA curve of a sample printed using the photosensitive polyimide resin obtained in Example 3. As could be seen from FIGS. 4 and 5, the printed samples using the photosensitive polyimide resin obtained in Examples 1 and 3 have good heat resistance and can withstand high temperature of more than 410° C.

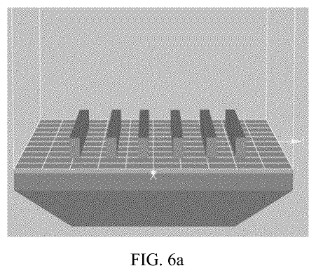

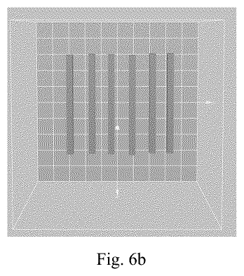

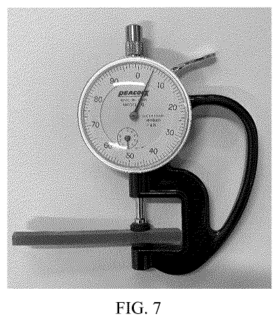

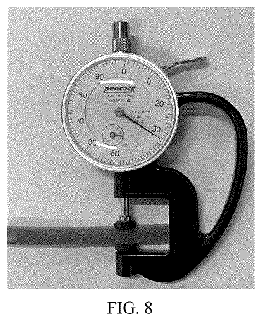

As shown in FIGS. 6a and ab, the photosensitive polyimide resin prepared in Example 1 was placed in a small square desktop-grade light-curing printer (dazzle-3D) to print impact strips. The impact strips were set in a center of the printing plane. Six impact strips were arranged longitudinally. The narrow surface was perpendicular to the printing surface. The printing conditions (thickness, width, and length) were 5.00 mm, 7.30 mm, and 10.00 mm. The number of printing layers was 100. The consumable mode was “transparent - advanced”. The thickness and width of the printed impact strips was tested, as shown in FIGS. 7 and 8.

The readings in FIG. 7 and FIG. 8 were as follows: FIG. 7: 5.05 mm, and FIG. 8: 7.32 mm.

It should be noted that described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A photosensitive polyimide resin for ultraviolet (UV) curing-based three-dimensional (3D) printing, wherein raw materials for preparation of the photosensitive polyimide resin comprise:
40-60 parts by weight of an active group-containing polyimide resin;
20-50 parts by weight of an organic activator; and
2-5 parts by weight of a photoinitiator;
wherein the organic activator comprises methyl methacrylate (MMA) and 1-vinyl-2-pyrrolidone (NVP).

2. The photosensitive polyimide resin of claim 1, wherein raw materials for preparation of the active group-containing polyimide resin comprises:
5-15 parts by weight of 2-(4-aminophenyl)-5-aminobenzimidazole (APBIA);
10-20 parts by weight of 3,3′,4,4′-benzophenone tetracarboxylic dianhydride (BTDA);
0.03-0.05 part by weight of triethylamine (TEA);
1.71-5.12 parts by weight of glycidyl methacrylate (GMA);
0.12-0.36 part by weight of a polymerization inhibitor; and
a solvent.

3. The photosensitive polyimide resin of claim 2, wherein the polymerization inhibitor is selected from the group consisting of hydroquinone, 2-tert-butylhydroquinone (TBHQ), 2,5-di-tert-butylhydroquinone (DBHQ), and a combination thereof.

4. The photosensitive polyimide resin of claim 2, wherein the solvent is selected from the group consisting of N-methylpyrrolidone (NMP), N,N-dimethylformamide, N,N-dimethylacetamide, and a combination thereof.

5. A method for preparing the photosensitive polyimide resin of claim 1, comprising:
adding the active group-containing polyimide resin, the organic activator and the photoinitiator in a ball grinding mill followed by grinding in the dark for uniform mixing to obtain the photosensitive polyimide resin.

6. The method of claim 5, wherein the active group-containing polyimide resin is prepared through steps of:
adding APBIA into a solvent to obtain a first mixture;
adding BTDA into the first mixture for reaction to obtain a second mixture; and
adding TEA, GMA, and a polymerization inhibitor into the second mixture for condensation reaction to obtain the active group-containing polyimide resin.

7. The method of claim 6, wherein the step of “adding BTDA into the first mixture for reaction to obtain a second mixture” comprises:
adding BTDA into the first mixture in an ice-water bath followed by stirring in an inert gas atmosphere, reaction in a hydrothermal reactor, reaction at a low temperature, and reaction in a heating system, so as to obtain the second mixture. 8. The method of claim 7, wherein the heating system is successively set at 120° C. for 2 h, 160° C. for 2 h, and 200° C. for 12 h.

9. The method of claim 7, wherein the “reaction at a low temperature ” is carried out at 4° C. for 24 h.

10. The method of claim 6, wherein the condensation reaction is carried out at 100° C. for 5 h.
